(19) United States
(12) Patent Application Publication
(10) Pub. No.: US 2025/0318549 A1
(43) Pub. Date: Oct. 16, 2025

(54) MEAT SUBSTITUTE PRODUCT

(71) Applicant: CARGILL, INCORPORATED, Wayzata, MN (US)

(72) Inventors: Yun GE, Nantong (CN); Guifang CHANG, Shanghai (CN); Ping CHEN, Auckland (NZ); Yaobin SI, Shanghai (CN); Weiqiang ZHOU, SHANGHAI (CN)

(21) Appl. No.: 18/865,272

(22) PCT Filed: May 18, 2022
(86) PCT No.: PCT/CN2022/093464

§ 371 Date: Nov. 12, 2024

(51) Int. Cl. A23J 3/22; A23D 9/00; A23K 10/30; A23K 20/147; A23K 20/158; A23K 50/40

(52) U.S. Cl. CPC A23J 3/227; A23D 9/00; A23K 10/30; A23K 20/147; A23K 20/158; A23K 50/40

(57) ABSTRACT

An emulsified oil containing oil in an amount of 15% to 40%, water in an amount of 55% to 75% and an emulsion-stabilizer in an amount of 2% to 10%. It relates further to a meat substitute product comprising the emulsified oil. The invention further relates to the use of palm kernel oil stearin, coconut oil stearin or mixtures thereof for improving the texture and/or organoleptic properties of a ground meat substitute product. Preferably the meat substitute product is a vegetarian ground meat substitute product that is shaped into a form such as a burger, a patty, a meatball, a nugget or a sausage.

### FIELD OF THE INVENTION

The present invention relates to an emulsified oil comprising an oil, water and a stabilizer wherein the oil has a melting point of 27 to 35° C., and a meat substitute product comprising this emulsified oil. The invention further relates to the use of use palm kernel oil stearin or coconut oil stearin or mixtures thereof, for improving the appearance, texture and/or organoleptic properties of a ground meat substitute product. Preferably the meat substitute product is a vegetarian ground meat substitute product that is shaped into a form such as a burger, a patty, a meatball, a nugget or a sausage.

### BACKGROUND OF THE INVENTION

Traditionally, meat products have taken an important place in our western diet. Meat products are consumed in many different forms as whole muscle or minced pieces of meat that are cooked, grilled, smoked, cured or fermented in form of hamburgers, patties, sausages, meat balls, nuggets and many more.

There is a growing consumer trend for reducing or completely removing these animal products from their diet. Consumers switch towards plant-based meat substitutes because of various reasons such as health concerns, environmental concerns, sustainability or animal welfare.

In order for a regular meat consumer to be motivated to choose for meat substitutes, it is critical that these substitutes mimic the fibrous qualities provided by animal muscle fiber. The meat substitutes should resemble meat products in terms of appearance and texture during and after cooking. They should mimic organoleptic properties, like appearance, flavor, bite, succulence and mouthfeel when being consumed.

Various functional ingredients in meat substitutes are required to mimic the taste, flavor, texture, mouthfeel and appearance of meat-based products. There are still many technical challenges to make plant-based meat more similar with animal meat. By using ordinary vegetable oil, it is difficult to get the similar texture and taste.

There is still a need to improve the appearance, texture and/or organoleptic properties of meat substitutes and more specifically of ground meat substitutes. The present invention provides such a solution.

### SUMMARY OF THE INVENTION

The present invention relates to an emulsified oil comprising an oil, water and a stabilizer wherein the oil has a melting point of 27 to 35° C.

The invention further relates to a meat substitute product comprising at least one texturized protein ingredient and the emulsified oil of the present invention.

Furthermore, the invention relates to the use palm kernel oil stearin or coconut oil stearin or mixtures thereof, for improving the appearance, texture and/or organoleptic properties of a ground meat substitute product.

Finally, it relates to flakes of palm kernel stearin, coconut oil stearin or mixtures thereof.

### DETAILED DESCRIPTION

The present invention relates to an emulsified oil comprising an oil, water and a stabilizer wherein the oil has a melting point of 27 to 35° C.

In view of the potential applications, the oil has a relatively steep solid fat curve with melting point of 27 to 35° C.

The fatty acid moiety of the oil has a content of lauric acid (C12) of 40 to 65% and medium carbon chain fatty acid (C6 to C12) content of 50% to 75% based on total weight of the fatty acid moiety.

The fats a melting point of 27 to 35° C., also described as solid fats, are mainly made from the fractionation of lauric fats, such as the fractionation of palm kernel oil or coconut oil. The oil in the emulsified oil of the present invention can be selected from palm kernel oil stearin, coconut oil stearin or mixtures thereof.

The palm kernel oil stearin or coconut oil stearin is prepared by fractionation of the corresponding oil. In order to have a cleaner flavour the stearin fraction is bleached and deodorized using known standard refining conditions. The thus obtained refined stearin fraction is then solidified into a hard solid and sliced into fat flakes. The flakes allow for easy handling.

The stabilizer is based upon hydrocolloids. Hydrocolloids are polysaccharides of high molecular weight, extracted from plants, seaweeds or produced by microbial synthesis. Hydrocolloids are substances that form colloidal systems when dispersed in water. Examples of hydrocolloids are starches, xanthan gum, guar gum, locust bean gum, gum Arabic, konjac gum, cellulose derivatives, alginate, pectin, carrageenan, gellan gum, agar, plant fibers or combinations of two or more thereof.

Starches may be from various botanical sources, such as potato starch or maize starch. They may be in form of native starch, physically or chemically modified starch, hydrolysed starches such as maltodextrins and glucose syrups, or combinations of two or more thereof.

Glucose syrup and maltodextrin are starch hydrolysates, i.e. poly-or oligosaccharides obtained by partial hydrolysis of starch. They are classified by their dextrose equivalent (DE).

The term “maltodextrin” is encompassing starch hydrolysates having a DE of from 3 to 20. The term “glucose syrup” is encompassing starch hydrolysates having a DE of more than 20.

Cellulose derivatives may be methyl cellulose, carboxymethyl cellulose and/or hydroxypropyl methylcellulose.

Plant fibers may be citrus fiber, carrot fiber or chicory root fiber.

Preferably, the one or more hydrocolloids are selected from the group consisting of starch, cellulose derivates, carrageenan, xanthan gum or fiber.

In a preferred aspect, the stabilizer of the emulsified oil of the present invention is comprising methylcellulose, guar gum, Arabic gum and maltodextrins.

Once the emulsified oil is applied in meat alternative product, the stabilizer acts as a binder, providing adhesion to uncooked product and when heated provides gelation that lends to a meat like structure with realistic firmness and springiness while retaining and increasing the perception of juiciness.

This may influence the moistness and succulence of the meat alternative product and may also influence the firmness of bite.

In the emulsified oil of the present invention, the oil is present in an amount of 15% to 40%, water is present in an amount of 55% to 75% and the stabilizer is present in an amount of 2% to 10% based on total weight of the emulsified oil.

The present invention relates to a meat substitute product.

Meat substitute products are food or feed compositions that mimic animal processed whole-muscle meat products as well as processed restructured meat products such as burgers, patties, sausages and the like. Methods of processing may be salting, chopping, fermentation, boiling, smoking, extrusion or other processes.

Meat substitute products can be divided into ground, also called minced, products and fine paste products. Ground meat substitute products are coarse-particle products such as alternatives for burgers, patties, sausages, meatballs, nuggets and the like. Fine paste products are typically emulsified products such as alternatives for frankfurter, bologna, mortadella and the like.

In one aspect of the invention, the meat substitute product is a ground meat substitute. The ground meat substitute product may be shaped in a form, such as the form of a burger, a patty, a meatball, a nugget or a sausage. In a preferred aspect of the invention, the meat substitute product is a ground and shaped meat substitute.

In another aspect of the invention, the ground meat substitute product is a ground vegetarian protein product. The ground vegetarian protein product is not based on meat or fish. More preferably the ground meat substitute product is a ground vegan protein product. The ground vegan protein product is not based on products derived from animals. Examples of products derived from animals are amongst others meat, fish, eggs, milk or honey.

The meat substitute product of the present invention is typically designed for consumption after cooking.

Alternatively, the meat substitute product of the present invention is a pet food. The term “pet food” means any food composition intended to be consumed by a pet. A pet may be any domestic or tamed animal kept for companionship or pleasure. For example, the pet can be an avian, bovine, canine, equine, feline, hircine, lupine, murine, ovine, or porcine animal. Preferably, the pet is a dog or a cat.

The meat substitute product of the present invention is comprising at least one texturized protein ingredient and the emulsified oil of the present invention.

A texturized protein is a fibrous protein product. It may enhance the textural and sensorial quality of the meat substitute product. It may influence the bite, succulence and/or moistness of the meat substitute product.

Preferably the at least one texturized protein ingredient is from a vegetable source, i.e. a texturized vegetable protein. A texturized vegetable protein is a processed vegetable product usually made from high protein flour or its protein concentrate through an extrusion process at high temperature and pressure to produce a fibrous, insoluble and porous product. The at least one texturized vegetable protein is sourced amongst others from soy, pea, corn, cottonseed, wheat, sunflower seed, oats or combinations of two or more thereof. More preferably, the at least one texturized protein ingredient is sourced from soy, pea, wheat, sunflower, or mixtures of two or more thereof. More preferably, the at least one texturized protein ingredient is texturized soy protein and/or texturized pea protein.

The meat substitute product of the present invention is comprising the emulsified oil in an amount of 30% to 60% based upon weight of meat substitute product.

In a further aspect of the invention, the texturized protein ingredient is present in an amount of 10% to 25% based upon weight of meat substitute product.

In yet one more aspect of the invention, the meat substitute product comprises one or more ingredients selected from sodium chloride, sodium ascorbates, citrates, sodium carbonates, sweeteners, flavoring agents, flavor enhancers, spices/seasonings and preservatives. The amount of each ingredient, if present, is preferably in a range of from 0.01 to 10.0 wt %, from 0.02 to 6.0 wt % on the total weight of the meat substitute product.

The current invention further relates to the use of palm kernel oil stearin or coconut oil stearin or mixtures thereof, for improving the appearance, texture and/or organoleptic properties of a ground meat substitute product.

Finally, the current invention relates to flakes of palm kernel stearin, coconut oil stearin or mixtures thereof.

The meat substitute product according of the present invention that is comprising the emulsified oil of the present invention has an improved mouthfeel and texture compared to a meat substitute product that is comprising an oil such as rapeseed oil or coconut oil.

The specific melting behavior of the emulsified oil results in a meat substitute product of the present invention with a pleasant fatty and succulent mouthfeel. The meat substitute product has a good integrity during baking, frying and/or handling of the product.

The meat substitute product may be prepared in a process where the at least one texturized protein ingredient is hydrated and subsequently mixed with the rest of the dry ingredients and water in order to obtain a doughy product, i.e. the meat substitute dough. All steps for the preparation of the meat substitute dough are executed at a temperature below 8° C.

The meat substitute dough is subsequently shaped into a form, such as a burger, a patty, a meatball, a nugget, a sausage or the like. The shaped forms can be stored at 4° C., can be frozen at −18° C. or can be heat treated (like steam cooking, pan frying or oven baking) prior to storing at 4° C. or freezing at −18° C.

It has been found amongst others that the emulsified oil of the present invention greatly improved the texture, taste, flavor and other aspects of plant-based meat compared the other ordinary vegetable oils.

### EXAMPLES

### 1. Preparation of Flakes of Palm Kernel Oil Stearin

Palm kernel stearin (PKST; iodine value is 6.1 g/100 g) was obtained from palm kernel oil (PKO; iodine value of 18.3 g/100 g) by high pressure fractionation.

PKST was then proceeded with standard bleaching and deodorization process to obtain RPKST (refined palm kernel stearin).

RPKST was cooled below 30° C. to solidify into a hard solid, and then sliced to obtain fat flakes for easy handling.

The fatty acid composition and the solid fat content (SFC) of the palm kernel stearin are shown in table 1.

TABLE 1
fatty acid composition and Solid fat
content of palm kernel oil stearin
Solid Fat Content

| | |
|---|---|
| 10° C. | 93.2 |
| 20° C. | 88.0 |
| 25° C. | 76.7 |
| 30° C. | 40.9 |
| 35° C. | 0.0 |
| 40° C. | 0.0 |

Fatty acid composition of palm kernel oil stearin

| | |
|---|---|
| C6 | 0.1 |
| C8 | 1.7 |
| C10 | 2.6 |
| C12 | 54.5 |
| C14 | 22.9 |
| C16 | 9.6 |
| C18 | 2.0 |
| C18:1 | 5.6 |
| C18:2 | 0.8 |
| Medium chain C6-C12 | 58.8 |

### 2. Preparation of Emulsified Oil

28% fat flakes by weight (obtained by Example 1) are added to 6% by weight of the stabilizer MCK 902 (Cargill compound stabilizer: the main ingredients are methylcellulose, Arabic gum, guar gum, maltodextrin). The remaining addition of 66% by weight ratio of ice water (temperature 0-4° C.), high-speed shear (3500-5000 rpm) 8 minutes −10 minutes to obtain emulsified oil.

### 3. Recipe of the Meat Substitute Product

The recipe of the meat substitute products is shown in table 2.

TABLE 2

| Beef Patties Recipe | Content |
|---|---|
| Textured soy protein (After rehydration) | 18.3% |
| Ice water | 30.2% |
| Emulsified oil of example 2 | 45% |
| Seasonings | 6% |
| Pigments (Beet red & Caramel colour) | 0.5% |

### 4. Preparation of the Meat Substitute Product

The texturized soy protein was well hydrated in advance about 2-4h to ensure rehydration sufficient, and then dehydrated and dried. The proportion of rehydration is 1:1.7.
For a total of 500 g ingredients, proportionally according to the recipe of Table 2, textured soy protein, ice water, emulsified oil, seasoning (Model G75969X1, from Newly weds company) and pigment (from Sensient Technologies Corporation), were fully stirred and mixed.
The beef patties are shaped in the mold.
The patties are roasted at 180° C. in the oven for 10 minutes.

The sensory evaluation of plant-based meat is evaluated from the aspects of molding status, hardness and chewiness, juicy, taste.

The sensory group consists of 5 people, and the score from 1-5 indicates that 1 is unacceptable, 2 is acceptable, 3 is general 4 is good, and 5 is excellent.

The results of the sensory evaluation are shown in Table 3

TABLE 3

| | Use of Emulsified palm | |
|---|---|---|
| | kernel oil stearin in | Comparison with |
| | patty | emulsified coconut oil |
| Oil SMP (° C.) | 32 | 26 |
| Oil SFC (%) | | |
| 10° C. | 94.3 | 79.2 |
| 20° C. | 88.6 | 37.3 |
| 30° C. | 41.3 | 0 |
| 40° C. | 0.0 | 0 |
| Convenience of | Very convenient | Not convenient |
| handling | | |
| Molding status of | 5 | 4 |
| patties | | |
| Hardness and | 5 | 4 |
| Chewiness of patties | | |
| Juicy of patties | 4 | 3 |
| Taste and flavor of | 5 | 4 |
| patties | | |

Convenience of handling: easy handling, because the palm kernel stearin flakes can be added to the emulsified blends directly without melting. For the coconut oil, the oil is half solidify and not homogeneous, it has to be heated and melted to add to the emulsified blends.

Molding status of patties: is evaluated by a sensory panel with 5 professional peoples. Hardness and Chewiness of patties: is evaluated by a sensory panel with 5 professional peoples.

Juicy of patties: is evaluated by a sensory panel with 5 professional peoples. Taste and flavor of patties: is evaluated by a sensory panel with 5 professional peoples.

1. An emulsified oil comprising an oil, water and a stabilizer wherein the oil has a melting point of 27 to 35° C.

2. The emulsified oil according to claim 1 wherein the fatty acid moiety of the oil has a content of lauric acid (C12) of 40 to 65% and medium carbon chain fatty acid (C6 to C12) content of 50% to 75% based on total weight of the fatty acid moiety.

3. The emulsified oil according to claim 1, wherein oil is present in an amount of 15% to 40%, water is present in an amount of 55% to 75% and the stabilizer is present in an amount of 2% to 10%.

4. A meat substitute product comprising at least one texturized protein ingredient and the emulsified oil according to claim 1.

5. The meat substitute product according to claim 4, wherein the emulsified oil is present in an amount of 30% to 60% based upon weight of meat substitute product.

6. The meat substitute product according to claim, 4 wherein the texturized protein ingredient is present in an amount of 10% to 25% based upon weight of meat substitute product.

7. The meat substitute product according to claim 4, wherein the meat substitute product is a ground meat substitute product.

8. The meat substitute product according to claim 4, wherein the meat substitute product is a ground vegetarian protein product.

9. The meat substitute product according to claim 4, wherein the meat substitute product is a pet food.

10. Use of palm kernel oil stearin or coconut oil stearin or mixtures thereof, for improving the appearance, texture and/or organoleptic properties of a ground meat substitute product.

11. Flakes of palm kernel stearin, coconut oil stearin or mixtures thereof.
